(19) United States
(12) Patent Application Publication
(10) Pub. No.: US 2016/0182942 A1
(43) Pub. Date: Jun. 23, 2016

(54) Real Time Combination of Listened-To Audio on a Mobile User Equipment With a Simultaneous Video Recording

(71) Applicant: Telefonaktiebolaget LM Ericsson (publ), Stockholm (SE)

(72) Inventors: Hongxin Liang, Upplands Väsby (SE); Leonid Mokrushin, Uppsala (SE); Farjola Peco, Solna (SE)

(73) Assignee: Telefonaktiebolaget L M Ericsson (publ), Stockholm (SE)

(21) Appl. No.: 14/911,066

(22) PCT Filed: Aug. 12, 2013
(86) PCT No.: PCT/EP2013/066801

§ 371 Date: Feb. 9, 2016

(51) Int. Cl. H04N 21/433; G11B 27/031; G11B 27/32; H04N 21/222; H04N 21/231; H04N 21/258; H04N 21/414; H04N 21/4223; H04N 21/432; H04N 21/45; H04N 21/61; H04N 21/658; H04N 21/84; H04N 21/854; H04N 21/858; G06F 17/30

(52) U.S. Cl. CPC H04N 21/4334; G06F 17/30241; G11B 27/031; G11B 27/322; H04N 21/2223; H04N 21/23109; H04N 21/25841; H04N 21/41407; H04N 21/4223; H04N 21/4325; H04N 21/4524; H04N 21/6131; H04N 21/6181; H04N 21/6582; H04N 21/84; H04N 21/854; H04N 21/858

(57) ABSTRACT

A user equipment (UE) (10) used by a user (12) includes radio circuitry (26) for communicating information with a radio network and a user interface (22) that receives user input and provides audio and visual output. The UE generates audio from an audio source (28) selected by the user and plays the generated audio for listening by the user via the user interface. In response to the user input, the UE activates a video recording camera (24) included in the UE to record video inlitanation associated with a scene being viewed by the user. The UE combines in real time audio information associated with the generated audio and the recorded video information and stores the mixed information for subsequent playback by the user.

### TECHNICAL FIELD

The technology relates to real time multimedia recording using a mobile radio user equipment (UE).

### BACKGROUND

UE users often use their UEs to listen to music or other audio (e.g., read-aloud books, poetry, plays, etc.) and many UEs also have cameras. The user listening to music may realize that a visual, such as a beautiful landscape scene, the user is currently seeing and experiencing matches that music. The user may be inspired just at that instant to want to capture the synergistic momentary experience of the scene and the sound by using the user's UE to make a video of the scene combined with the music.

This is quite different from recording video and later on processing that video using some sort of studio or video editing software to add in audio. Rather, the inventors recognized that many times combined visual and audio experiences that are recognized in the moment as pleasurable, inspirational, or unique are ad-hoc, emotional, and transitory. The context and emotion associated with a particular sound track and a passing scene are typically lost as soon as the moment has past and are not recaptured at a later time when video editing and supplication is conventionally done. Indeed, the delay allows other tasks and distractions to divert most users from even thinking about or trying to recapture the video-audio synergistic moment experienced by the user.

### SUMMARY

The technology in this application includes methods and apparatus that allow a UE user to link in real time audio currently being played by the UE and video being recorded using the UE as it is being experienced and recorded by that user while listening to the played audio. Indeed, the experience of real time video recording and audio listening provides inspiration that might not otherwise be captured by just video recording without including the experienced audio.

The UE used by the user includes radio circuitry for communicating information with a radio network and a user interface that receives user input and provides audio and visual output. The UE generates audio from an audio source selected by the user and plays the generated audio for listening by the user via the user interface. In response to the user input, the UE activates a video recording camera included in the UE to record video information associated with a scene being viewed by the user. The UE links in real time audio information associated with the generated audio and the recorded video information and stores the linked information for subsequent playback by the user. The stored information may be retrieved and the recorded video information played along with the linked audio using the stored audio information.

The audio information may include one or more of the following: audio, audio metadata, and streaming audio received from a streaming server via the radio network and the radio circuitry. If the played audio is associated with metadata, and the metadata detected and stored as part of the linked information.

The linked information may be stored for subsequent playback by the user in response to the user activating a linked function.

In example implementations, the linked information is uploaded to another computing device via the radio circuitry. The linked information may also be shared on the Internet via the radio circuitry.

Example server embodiments are also described.

### BRIEF DESCRIPTION OF THE FIGURES

FIG. 1 is a diagram showing a user experiencing audio and a beautiful scene in real time;

FIG. 2 is function block diagram of a UE configured for communication with one or more servers via a communications network;

FIG. 3 is a flow chart illustrating example procedures for real time multimedia recording using a mobile radio user equipment;

FIG. 4A is a function block diagram showing of an example UE;

FIG. 4B is an example of associated audio linked to recorded video;

FIG. 4C show example formats for storing linked audio and video;

FIG. 5 is a flow chart illustrating example procedures for real time multimedia recording using a mobile radio user equipment in accordance with an example implementation;

FIG. 6 is a flow chart illustrating example procedures for real time multimedia playback using a mobile radio user equipment in accordance with an example implementation;

FIG. 7 is a function block type diagram illustrating an example server embodiment for recording, uploading, and downloading/playback;

FIG. 8A is an example mix recommendation server embodiment;

FIG. 8B is an example location recommendation server embodiment;

FIG. 9 is a flow chart illustrating example procedures for a recording server;

FIG. 10 is a flow chart illustrating example procedures for a mix recommendation embodiment; and

FIG. 11 is a flow chart illustrating example procedures for a location recommendation embodiment.

### DESCRIPTION OF NON-LIMITING EXAMPLE EMBODIMENTS

The following sets forth specific details, such as particular embodiments for purposes of explanation and not limitation. But it will be appreciated by one skilled in the art that other embodiments may be employed apart from these specific details. In some instances, detailed descriptions of well known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, etc.) and/or using software programs and data in conjunction with one or more digital microprocessors or general purpose computers. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

It should be understood by the skilled in the art that “UE” is a non-limiting term comprising any wireless device or node equipped with a radio interface allowing at least transmitting signals and receiving and/or measuring signals, a user interface for accepting user inputs and for providing outputs including audio and visual outputs, and a camera.

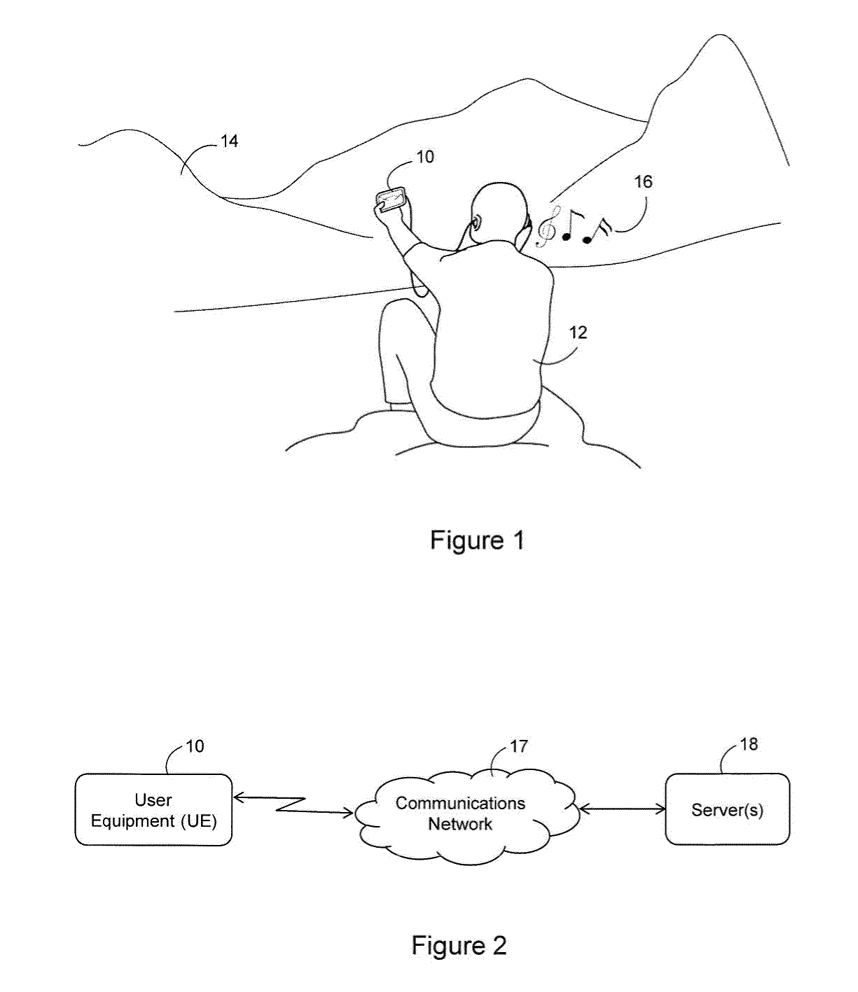

FIG. 1 is a diagram showing a user 12 with a UE 10 listening to audio 16 being generated by the UE 10 and viewing a beautiful scene 14. In real time, the user 12 captures the user's feeling and/or emotion just at that instant inspired by the synergistic momentary experience of the beautiful scene 14 and the playing audio 16 by recording the beautiful scene with a camera in the UE 10 to make a video of the scene, and at the same time, linking that video to the currently playing audio 16.

FIG. 2 is function block diagram of the UE 10 configured for communication over a radio interface with one or more servers 18 via a communications network 17. The communications network may for example include a cellular radio network and/or WiFi type network coupled to the Internet. Other communications networks may also be used. The server(s) 18 may provide online audio, storage services such as audio, video, and metadata storage, processing services, recommendation services, etc. for use by the UE 10.

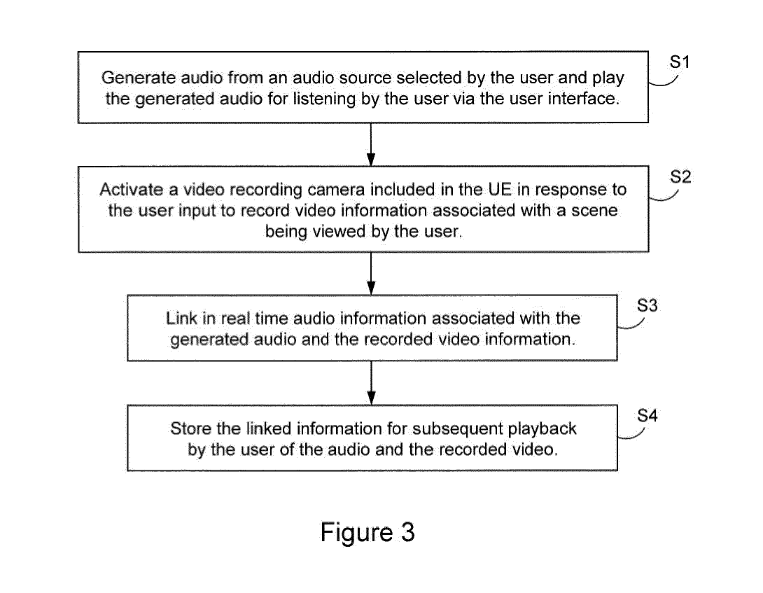

FIG. 3 is a flow chart illustrating example procedures for real time multimedia recording using a mobile radio user equipment. The UE generates audio from an audio source selected by the user and plays the generated audio for listening by the user via the user interface (step S1). In response to the user input, the UE activates a video recording camera included in the UE to record video information associated with a scene being viewed by the user (step S2). The UE links in real time audio information associated with the generated audio and the recorded video information (step S3) and stores the linked information for subsequent playback by the user (step S4). The stored information may be retrieved, and the recorded video information played along with the linked audio using the stored audio information.

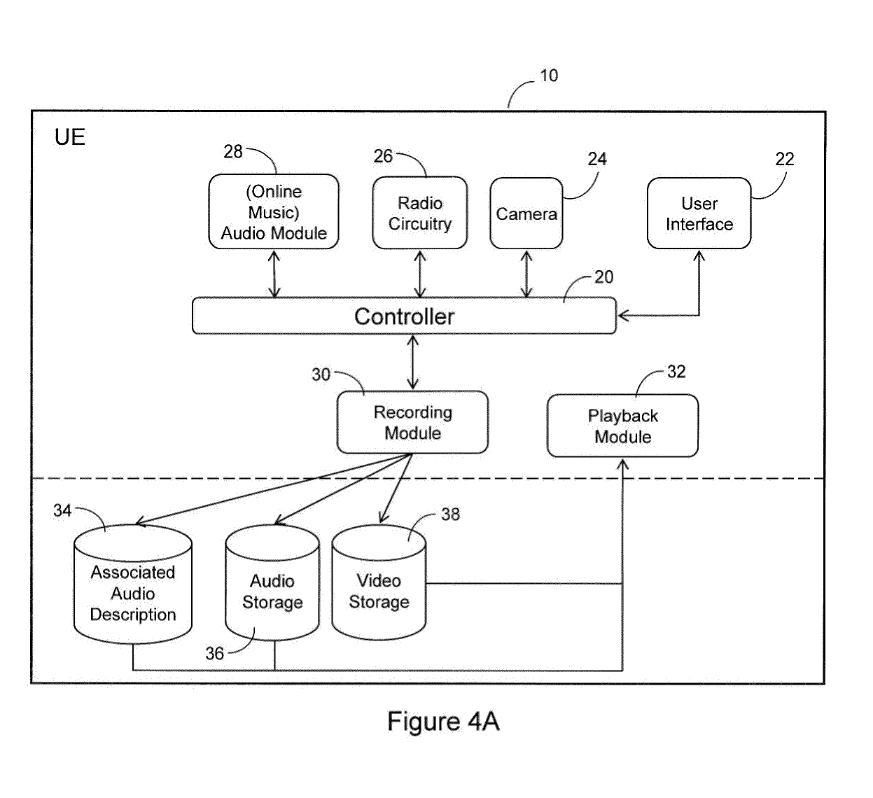

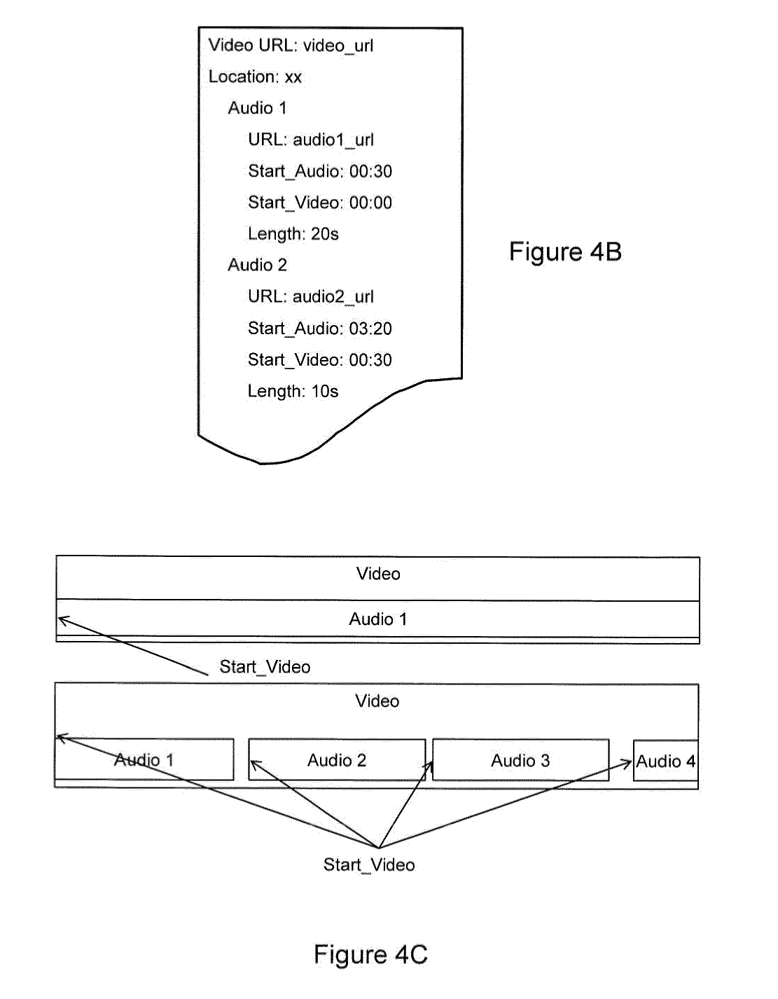

FIG. 4A is a function block diagram showing of an example UE 10. The UE includes a controller 20, e.g., one or more data processors running an operating system (OS) and various applications (Apps). The controller 20 communicates with a user interface 22, a camera 24, radio transmitting and receiving circuitry 26, and an audio module 28. A module may simply be a software program application executable by one or more data processors, or it may be a standalone piece of data processing hardware. The audio module 28 may play music files stored in the UE or online music streamed from the Internet or other source. The controller 20 also communicates with a video recording module 30 linked to the camera 24 and a playback module 32. The recording module 30 communicates with one or more stores including an associated audio description storage 34, audio storage 36, and video storage 38 that may be contained within the UE 10, or located outside the UE 10 but accessible by the UE.

As explained above, when the user 12 is listening to certain audio, e.g., music, the user experiences a visual, e.g., a scene, that the user believes matches the audio. The user wants at that moment to record a video with that audio being played mixed in. The user starts the recording module 30 and recording with the camera 24. The recording module, in response, mixes the audio with or otherwise links the audio to the recorded video in real time. The final video can be stored in the UE, uploaded to a computer, or shared via Internet. That audio mixing or linking does not override the audio being recorded through the UE microphone. Instead, the recorded audio and listened to audio are combined for synergistic effect. Significantly, the audio being played and listened to is not interrupted, thereby continuing to provide inspiration and enjoyment for the user.

Rather than mixing in the audio to the video on-the-fly, metadata of the audio can be recorded that links the audio to the video. Metadata provides information about one or more aspects of the data. Non-limiting examples of metadata include a track ID if the audio is music, the geographic region at which the video is being taken, etc. FIG. 4B shows an example of associated audio and other information linked to recorded video. The “video URL” is the location where the video file is stored, and the “location” is for example the geographic, e.g., GPS, location of where the video was recorded. The “audio URL” specifies where the audio file is stored, the “start audio” the starting point of the audio, the “start video” the starting point of the video to specify where the audio starts in the video file, and the length of the audio piece. The Audio 2 information is included to indicate that multiple tracks may be associated with the video. FIG. 4C shows two example dispositions of linked audio and video information for a single audio track (top) and for four audio tracks (bottom).

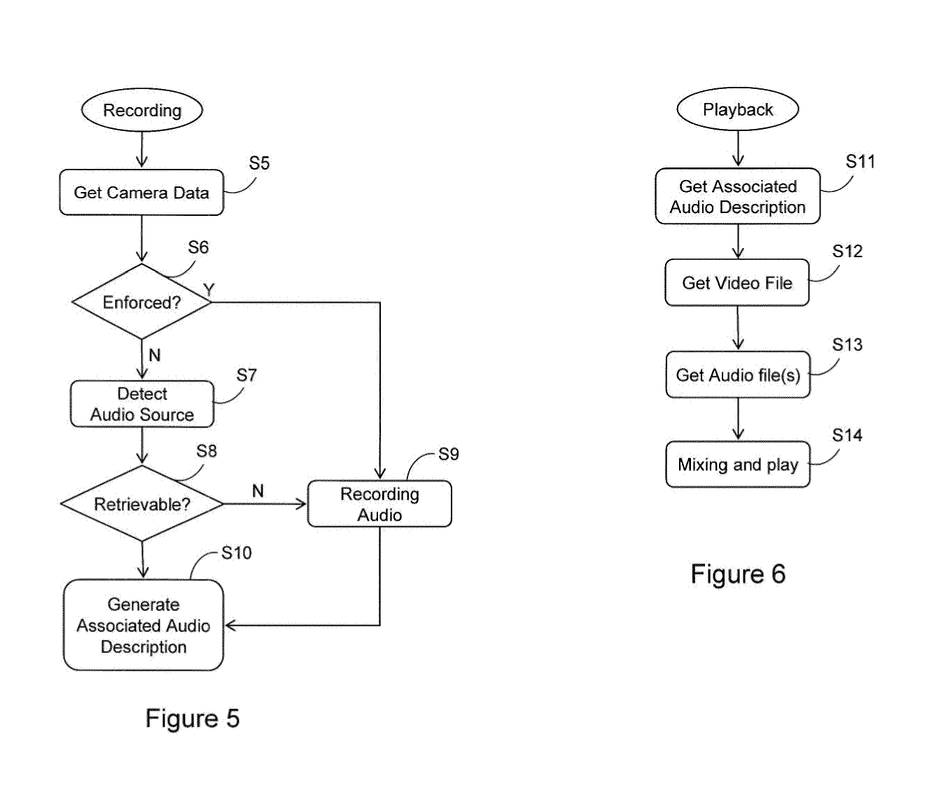

FIG. 5 is a flow chart illustrating example procedures for real time multimedia recording using a user equipment in accordance with an example implementation. The recording module 30 detects that the user has started or has requested start of video recording using the UE camera 24. The recording module 30 retrieves the camera video data (step S5), and determines whether the user has configured the recording module 30 to record the currently listened-to audio, regardless of whether that currently listened-to audio is retrievable or not (step S6). Retrievable audio means that the audio can be specified by a URL referring to either an online or local audio source for the currently listened-to audio. If the recording module 30 is so configured, control jumps to step S9 described below. If the recording module 30 is not so configured, it detects the audio source for the currently listened-to audio (step S7), and determines if that currently listened-to audio is retrievable (see definition above) from that source (step S8). If not, then the recording module 30 records the currently listened-to audio (step S9). Audio and video mixing does not necessarily mean that actual physical mixing occurs, although physical mixing may occur. For example, virtual mixing may occur without modifying the video. After recording the currently listened-to audio, the recorded audio file becomes a local resource and is retrievable. If the currently listened-to audio is retrievable, then the recording module 30 generates associated audio description information for the video being recorded (step S10). See the non-limiting examples shown in FIG. 4B.

FIG. 6 is a flow chart illustrating example procedures for real time multimedia playback using a user equipment in accordance with an example implementation. The playback module 32 in the UE 10 detects that the user would like to playback a recorded video with linked audio. The UE playback module 32 retrieves an associated audio description stored in store 34, the desired video file stored in 38, and the linked audio file(s) stored in 36 (steps S11-13). The playback module 32 mixes and plays the retrieved audio and video using the retrieved files (step 34) to recreate the user's multimedia experience. If not configured to do physical mixing, during playback both video and audio content are retrieved and playback occurs without modification.

The technology includes further server-involved embodiments. For example, an online music provider hosting a sharing service may want to use music selections and recorded video linked together by one user to make suggestions and/or provide resources for other users. For example, when a particular user is listening to certain music, the online music service can recommend/list videos associated with that music. By collecting a library of videos associated with music, processing the video with image recognition and/or GPS tag, the online music provider may also provide other services such as suggest certain music and/or videos when a user is visiting a location with a beautiful landscape, commuting on the train, taking a walk, etc. based on the videos recorded by other users. For example, the online service might suggest listening to “THRILLER” by Michael Jackson if a user is walking on certain road at nighttime.

As another example, suppose a user is listening to some music and wants to go somewhere for relaxing but would like ideas as to where to go. The online service provider, based on what the user is listening to and on mixed videos recorded by other users, may recommend certain areas in the vicinity of that user. One example suggestion from the online service provider sent via the Internet to the UE might be to take a walk at a nearby lake if the user is currently listening to peaceful/background music. The recommending online service provider, in addition to taking into account the music and video, may also use one or more sensors of the UE to enhance the recommendation, e.g., detecting whether the user is running or walking using an accelerometer or other sensor on the UE.

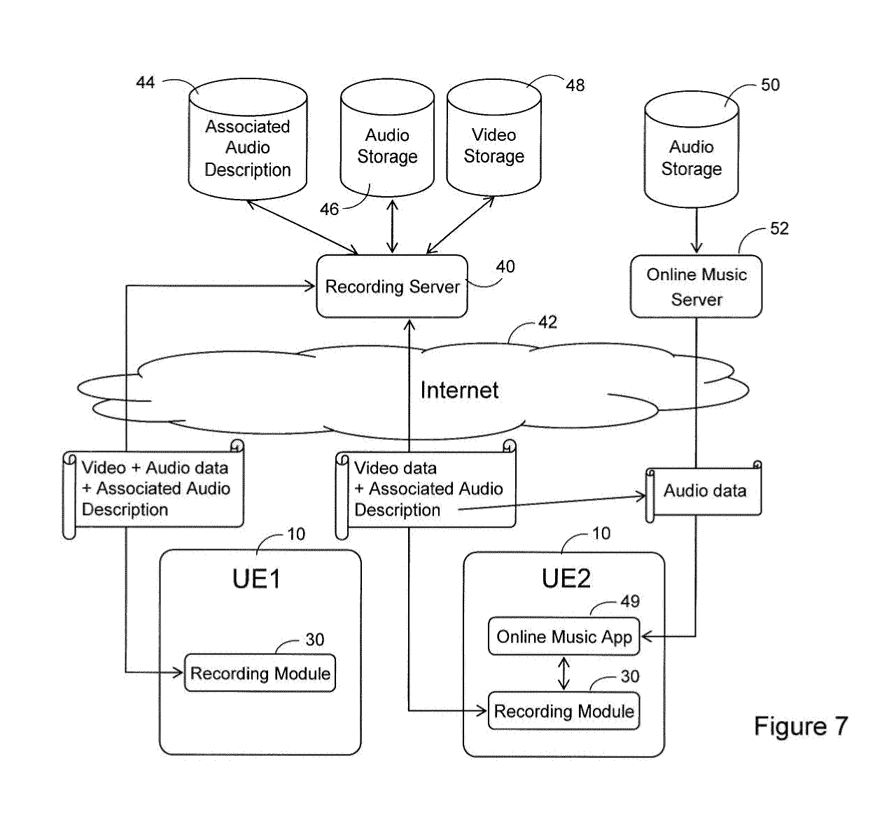

FIG. 7 is a function block type diagram illustrating an example server embodiment for recording, uploading, and downloading/playback. A recording server 40 communicates with associated audio description storage 44, audio storage 46, and video storage 48, each of which may be local to the server 40 or remote but accessible by the server 40. An online music server 52 communicates with audio storage 50, which also is local to the server 52 or is remote but accessible by the server 52. UEs 1 and 2 can communicate with one or both of the recording server 40 and online music server 52 via the Internet 42. In this illustration, UE1 contains a recording module 30 but not an online music application, and the user of UE1 records video and audio streams and generates corresponding associated audio description that links the video and audio streams. All three pieces of data are uploaded (preferably with user consent) to the recording server 40, which may be for example the backend of a recording application in the cloud. The UE2 contains a recording module 30 and an online music application (“app”) 49. The user of UE2 records a video stream using the recording module 30 while listening to an audio stream using the online music app 49. The video stream is recorded along with the associated audio description describing the segment of the audio from the online music server 52. The video data and associated audio description are uploaded (given user consent) to the recording server 40.

Alternatively, the user of UE1 requests playback of a certain user-created, audio-video mix (identified for example using a known ID) from the recording server 40 using the recording module 30. The UE1 downloads the video stream, the audio stream, and the associated audio descriptor from the recording server 40 and plays back the audio-video mix. The user of UE2 also requests playback of a certain user-created, audio-video mix (e.g., using a known ID) from the recording server 40 using the recording module 30. The UE2 downloads the video stream and the associated audio descriptor from the recording server 40 and requests the online music app 49 to open an audio stream according to the descriptor during video playback.

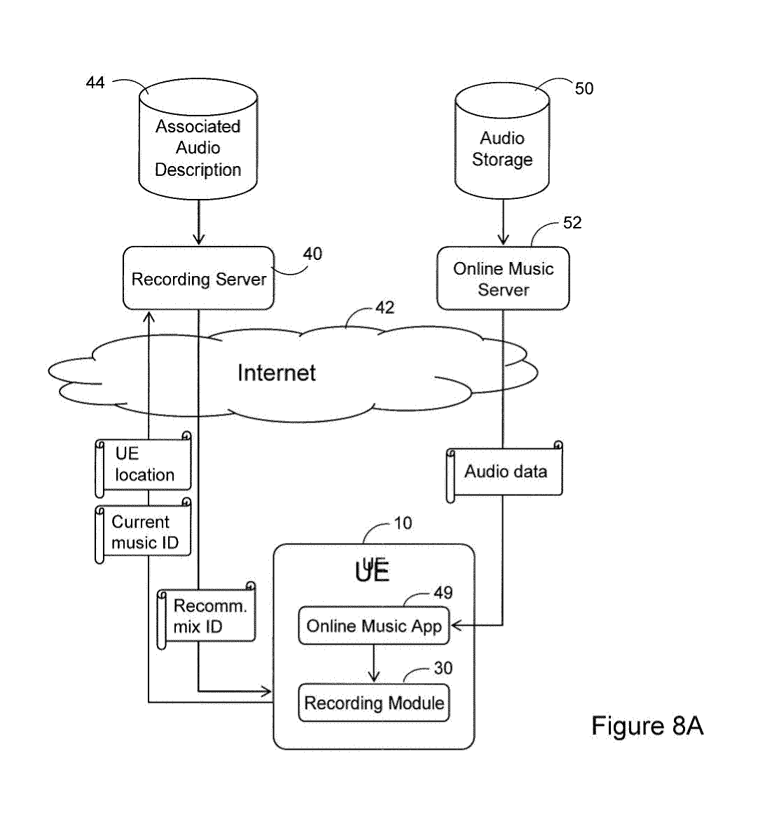

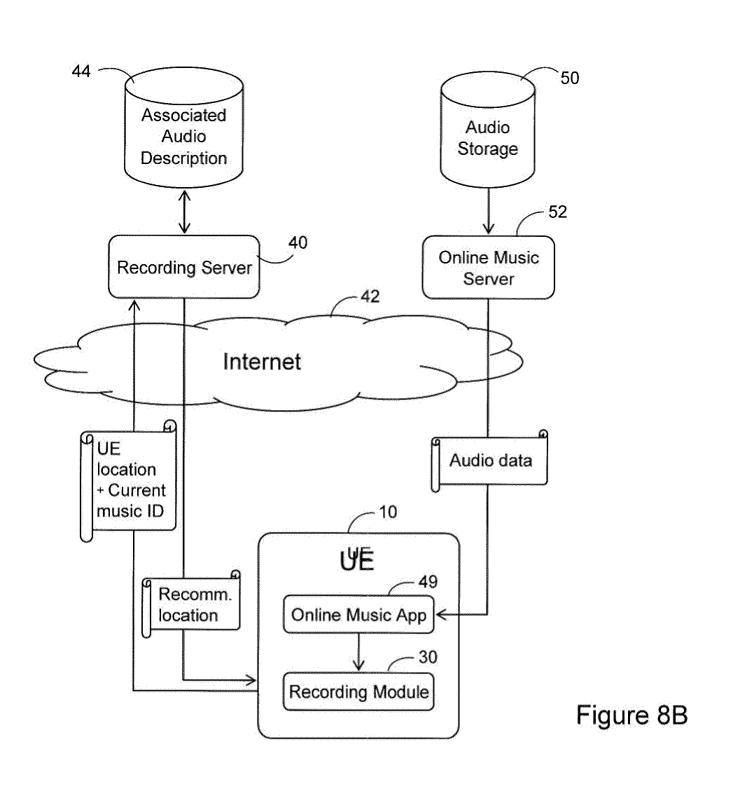

FIG. 8A is an example user-created, audio-video mix recommendation server embodiment. The recording app on the UE provides a “Recommend Mix” option, e.g., button, for activation or selection by the user. When the user 12 presses for example a “Recommend Mix” button on the user's UE, the recording module 30 sends the UE's geographic location and/or an identifier of the audio stream being currently played back by the online music app 49 (depending on availability) to the recording server 40. The recording server 40 invokes a recommendation algorithm that uses this data and the database of the associated audio descriptions in 44 to determine an identifier of a relevant user-created, audio-video mix and sends it to the recording module 30 on the UE 10. The UE 10 may then start playback of the recommended user-created, audio-video mix using playback procedures such as the example playback procedures described above.

FIG. 8B is an example geographic location recommendation server embodiment. The recording app on the UE provides a “Recommend Location” option, e.g., button, for activation or selection by the user. When a user presses for example a “Recommend Location” button in the recording app on the UE, the recording app sends UE's location and the identifier of the audio stream being currently played back by the online music app to the recording server. The recording server invokes a recommendation algorithm that uses this data and the database of the associated audio descriptions to determine a geographic location in the vicinity of the UE's location that is most appropriate to the currently played back audio stream. For example, the recording server may perform a search in the database 44 in order to find an audio-video mix containing the same audio stream identifier that was specified in the request from UE. If a non-empty list of results is returned by the database 44, then the recording server may recommend the location of the audio-video mix that most closely matches the UE current location. The recording app shows the recommended location on a map on the UE screen.

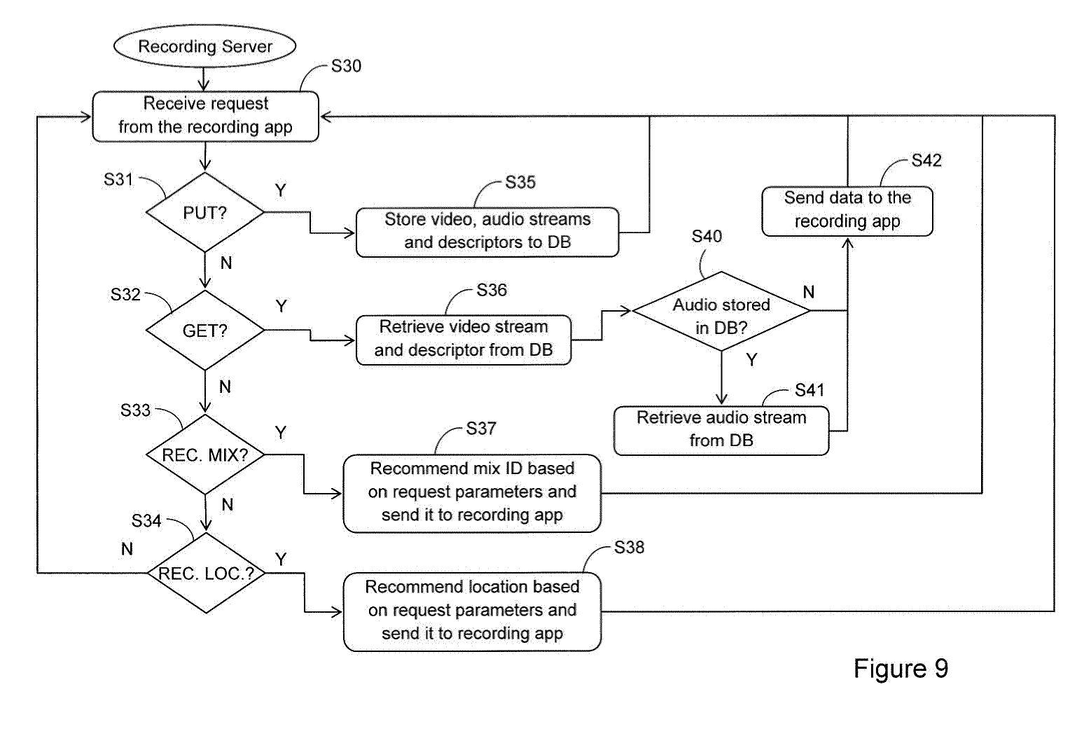

FIG. 9 is a flow chart illustrating example procedures for a recording server 40 including possible requests that it expects from an UE and actions that it may take in response to those requests. The recording server 40 receives a request from the UE's recording module 30 (step S30), and determines what type of request it is in steps S31-S34. If the recoding server detects a “PUT” request from UE in step S31, it stores video, audio stream(s), and descriptor(s) information in one or more suitable databases (step 35). Otherwise, if a “GET” request is detected in step S32, the recording server 40 retrieves video and audio descriptor information (corresponding to the audio-video mix identifier from the “GET” request) from the database and continues to decision block S40 where it is determined if audio is stored in the database. If so, then the audio stream is retrieved from the database (step S41). In any case, all retrieved data is sent to the recording module 30 of the UE (step 42) with control returning to step S30. In case the request from UE is neither “PUT” not “GET”, a decision is made in step S33 to determine whether the UE requested to recommend a audio-video mix (“REC.MIX.”) for current UE location and/or identifier of the currently listened-to audio stream both sent as part of the request. If so, then the recording server 40 recommends a audio-video mix ID based on request parameters from the UE, such as for example latitude, longitude, audio id like “http://spotify.com/id12532”, etc., and sends that mix ID to the recording module 30 in the UE (step S37), and control returns to S30. If not, then the recording server 40 determines in step S34 if the UE has requested to recommend a location (“REC.LOC.”), and if not, returns to S30. If so, then the recording server 40 recommends a location based on UE request parameters and sends that location to the UE's recording module 30 for display to the user (step S38) and control returns to S30.

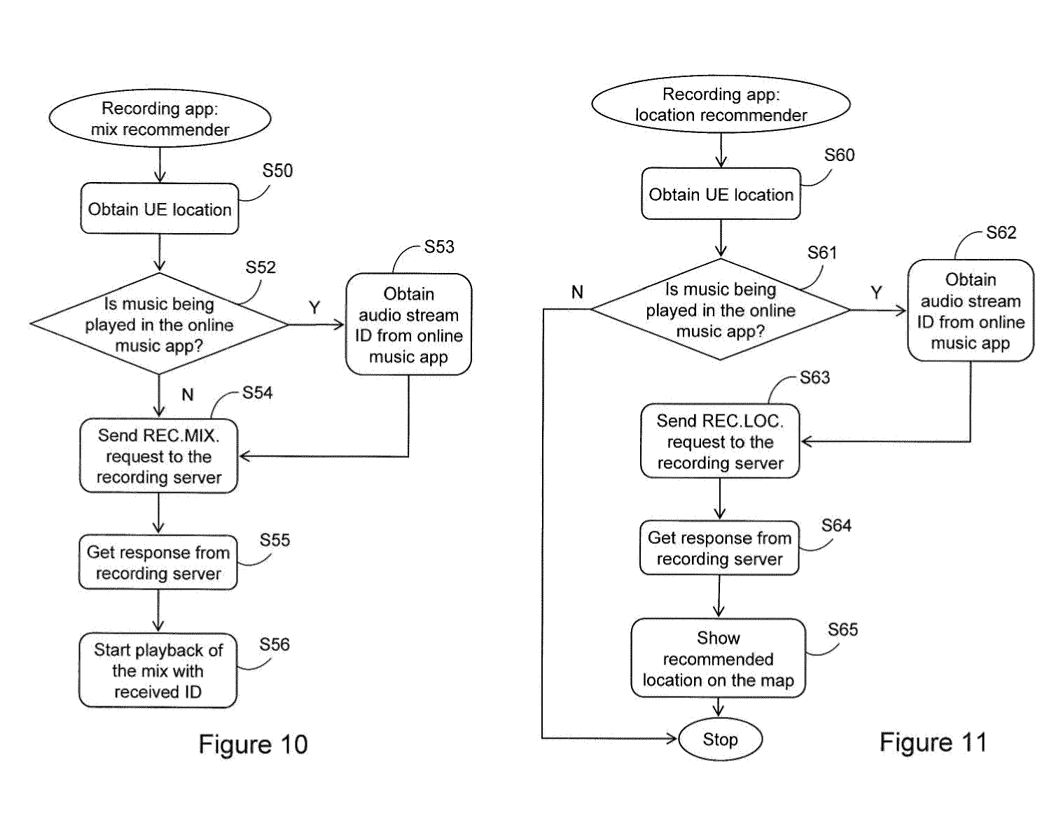

FIG. 10 is a flow chart illustrating example procedures for initiating and performing audio-video mix recommendation using a user equipment. The UE recording module 30 obtains the UE's current geographic location (step S50) and determines whether music is being played by the UE's online music app 49 (step S52). If so, the UE recording module 30 obtains the corresponding audio stream ID from the online music app 49 (step S53). If music is not being played by the online music app 49, then the UE recording module 30 sends a “recommend mix” request to the recording server 40 without a audio stream ID; otherwise, the UE recording module 30 includes it in the request. The recording module 30 then retrieves a response from the recording server 40 (step S5) and starts playback of the user-created, audio-video mix corresponding to the received audio-video mix identifier (step S6).

FIG. 11 is a flow chart illustrating example procedures for a location recommendation embodiment initiated by a user equipment. The UE recording module 30 obtains the UE's current geographic location (step S60) and determines whether music is being played by the online music app 49 of the UE (step S61). If not, then the UE recording module 30 ends this routine. But if music is being played by the online music app 49, the recording module 30 obtains the corresponding audio stream ID for the played music from the UE's online music app 49 (step S62) and sends a “recommend location” request to the recording server 40. The recording module 30 then retrieves a response from the recording server 40 (step S64) and displays on the UE screen a recommended location received in the response as a highlight on an image of a geographical map (step S65).

The technology described above performs real time, user-created, audio-video mixing to capture the context and emotion created by the combination of audio and visual experienced by a UE user. One of the advantages of the technology is the ability to capture the context and emotion associated with a particular sound track and a visual scene that are typically lost as soon as the moment has past and are not recaptured at a later time when video editing and supplication is conventionally done. Another technology advantage is the ability to share and automatically recommend audio-visual experience across a multitude of UE users.

Although the description above contains many specifics, they should not be construed as limiting but as merely providing illustrations of some presently preferred embodiments. Embodiments described herein may be considered as independent embodiments or may be considered in any combination with each other to describe non-limiting examples. Although non-limiting, example embodiments of the technology were described in a WCDMA context, the principles of the technology described may also be applied to other radio access technologies. Indeed, the technology fully encompasses other embodiments, which may become apparent to those skilled in the art. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for a device or method to address each and every problem sought to be solved by the described technology for it to be encompassed hereby.

1-15. (canceled)

16. A user equipment (UE) useable by a user, the UE comprising:
radio circuitry configured to communicate information with a radio network;
a user interface configured to receive user input and to provide audio and visual output;
a video recording camera configured to record a scene as directed by the user via the user interface;
data storage configured to store one or more video files, one or more audio files, and one or more computer programs;
data processing circuitry, coupled to the radio circuitry, the user interface, the video recording camera, and the data storage; the data processing circuitry configured to:
generate audio from an audio source selected by the user and play the generated audio for listening by the user via the user interface;
activate the video recording camera in response to the user input to record video information associated with a scene being viewed by the user;
combine in real time audio information associated with the generated audio and the recorded video information; and
store the mixed information for subsequent playback by the user.

17. The UE of claim 16, wherein the audio information includes at least one of: audio, audio metadata, and streaming audio received from a streaming server via the radio network and the radio circuitry.

18. The UE of claim 16, wherein the processing circuitry is configured to store the combined information in the data storage.

19. The UE of claim 16, wherein the processing circuitry is configured to upload the combined information to another computing device via the radio circuitry.

20. The UE of claim 16, wherein the processing circuitry is configured to share the mixed information on the Internet via the radio circuitry.

21. The UE of claim 16, wherein the data processing circuitry is configured to store the mixed information for subsequent playback by the user in response to the user activating a combining function.

22. The UE of claim 16:
wherein the played audio is associated with metadata;
wherein the data processing circuitry is configured to detect the metadata and store the detected metadata as part of the mixed information.

23. The UE of claim 16, wherein the data processing circuitry is configured to:
retrieve the stored mixed information; and
playback the recorded video information along with the mixed audio using the stored audio information.

24. A method implemented in a user equipment (UE) used by a user, the UE including radio circuitry configured to communicate information with a radio network and a user interface configured to receive user input and to provide audio and visual output, the method comprising:
generating, by way of one or more processing circuits, audio from an audio source selected by the user, and playing the generated audio for listening by the user via the user interface;
activating, by way of one or more processing circuits, a video recording camera included in the UE in response to the user input to record video information associated with a scene being viewed by the user;
combining in real time, by way of one or more processing circuits, audio information associated with the generated audio and the recorded video information; and
storing the mixed information for subsequent playback by the user.

25. The method of claim 24, wherein the audio information includes at least one of:
audio, audio metadata, and streaming audio received from a streaming server via the radio network and the radio circuitry.

26. The method of claim 24, further comprising storing the combined information for subsequent playback by the user in response to the user activating a combining function.

27. The method of claim 24, further comprising uploading the combined information to another computing device via the radio circuitry.

28. The method of claim 9, further comprising sharing the mixed information on the Internet via the radio circuitry.

29. The method of claim 24:
wherein the played audio is associated with metadata; and
further comprising detecting the metadata and storing the detected metadata as part of the mixed information.

30. The method of claim 24, further comprising:
retrieving the stored mixed information; and
playing back the recorded video information along with the mixed audio using the stored audio information.
